(19) United States
(12) Patent Application Publication
(10) Pub. No.: US 2024/0148016 A1
(43) Pub. Date: May 9, 2024

(54) FROZEN FOOD PRODUCT, NATURAL STABILIZER, FROZEN FOOD PRODUCTION METHOD AND THE SIEVE SYSTEM

(71) Applicants: Malgorzata OSIECKA-CIUHAK, Warsaw (PL); Krzysztof CIUHAK, Samaki (PL)

(72) Inventors: Anna Malgorzata OSIECKA-CIUHAK, Warszawa (PL); Pawel Krzysztof CIUHAK, Stare Litewniki (PL)

(21) Appl. No.: 18/548,983

(22) PCT Filed: Mar. 7, 2022
(86) PCT No.: PCT/PL2022/000015

§ 371 Date: Sep. 5, 2023

(30) Foreign Application Priority Data
Mar. 8, 2021 (PL) P.437238

(51) Int. Cl. A23G 9/20; A23G 9/34; A23G 9/36; A23G 9/42; A23L 29/206; A23L 29/269; A23L 33/135; B07B 1/46

(52) U.S. Cl. CPC A23G 9/20; A23G 9/34; A23G 9/363; A23G 9/42; A23L 29/206; A23L 29/269; A23L 33/135; B07B 1/4609

(57) ABSTRACT

The present invention relates to a frozen food product, a natural stabilizer, a method for producing a frozen food product, and a sieve system for forming beads of frozen food products. More specifically, the solution concerns cryogenic, natural, ice cream beads, shock-frozen in liquid gases used in cryogenics, adapted to typical cold chains with a temperature of −10° C. to −18° C., and cryogenic, natural, ice cream beads embedded in a homogeneous traditional natural ice cream mass.

The present invention relates to a frozen food product, a natural stabilizer, a method for producing a frozen food product, and a Sieve System for forming ice cream beads of frozen food products. More specifically, the solution concerns cryogenic, natural ice cream beads, shock-frozen in liquid gases used in cryogenics, adapted to typical cold chains at −10° C. to −18° C., and cryogenic, natural ice cream beads embedded in a homogeneous natural traditional ice cream.

Ice cream is not only a product made of frozen ice cream mass. Ice cream is a cold ice cream dessert, which belongs to the sweets desired by the consumer, and its consumption is primarily the pleasure of consuming, the pleasure of rubbing cold ice cream on the palate. Good ice cream should leave the palate with the pleasure of moisturizing like a good skin lotion, it should leave you feeling cold, and at the same time it should be soft and creamy, it should have an inviting form and inviting colors, it should have an interesting taste, sweetness and smell. Good ice cream should not melt too quickly and should leave a feeling of depth on the tongue for a distinctly long period of time. A frozen ice cream mass without the addition of stabilizing substances, sweeteners, colorants and flavors does not have above features. The sensory features of the product, i.e., taste, texture, creaminess, sweetness, color, shape, smell and quality of the ingredients from which it is made, make up the magic of ice cream, which we dream about as children, and in adulthood we associate it with the pleasure of eating and pleasant memories from childhood.

The history of ice cream dates back 5,000 years and began in China. Ice cream was also known in ancient Greece and Rome. Initially, it was in the form of a sorbet made from crushed ice, snow, fruit juice and milk, as well as honey. Gradually, the recipes were improved, changed, fermented milk and spices were used, followed by milk-egg creams. The resulting mass was cooled in snow. Moving to modern times, in the 13th century Marco Polo stole the recipe from the Chinese and delivered it to Venetian confectioners. The first flavor that was produced and that is popular to this day was the sweet cream flavor.

Due to the fact that sugar was a luxury commodity, ice cream with added sugar was intended only for the elite for a long period of time. Ice cream began to be mass produced in the United States.
[https://www.zezdrowiemmidosmaku.com/post/domowe-lody]

A separate type of ice cream desserts is granita, often confused with sorbet and ice cream.

In the 16th and 17th centuries, the temperatures in Sicily were much lower than they are today and heavy snowfall was common. Snow was stored in pits specially dug in the mountains and covered with straw. Snow was transported both by land and by ships. In the 16th century, at the time of malaria and plague epidemics, doctors began to use ice and snow chilled beverages to reduce fever in patients. This idea was brought from the Orient. Poor patients were administered with a drink made from water, lemon juice and ice, while for wealthier patients this drink additionally contained sugar. Salt was added to the ice to lower the temperature of the ice. At that time, these drinks start to be called sorbetto (from Arabic sharab).

Granita is prepared from fresh fruit or freshly squeezed fruit juice, pistachios, cocoa, and almonds, which are diluted with water with added sugar. Granita is formed by the freezing of water and does not contain air. To avoid the formation of pure ice particles, continuous granita agitation is required.

In the 17th century, granita went from Sicily to France, and the first ice cream parlor was also opened there, reportedly by a Sicilian aristocrat. Parisian confectioners came up with the idea to enrich the ice cream with flavorings, they started to modify granita by adding eggs, cream and milk.

In contrast to granita, sorbet is made from water and frozen fruits, juice, liqueur; whipped egg whites are also often added to give it a creamy texture. During freezing the sorbet, air enters it, which makes it more fluffy compared to granita.

Ice cream, on the other hand, is made from milk, sugar, cream, fruit and/or juice. In order to make the ice cream more fluffy and creamy, it is mixed in such a manner, so that air enters it during freezing.
[https://www.niemieckinasycylii.com/jak-powstaje-tradycyjna-sycylijska-granita/]

A very important feature of industrial ice cream is the possibility of storing it in typical cold chains. In typical cold chains, the temperature is guaranteed in the range from −10° C. to −18° C.

Ice cream adapted to typical cold chains can be distributed in modem distribution channels, which increases its availability to the consumer. Another very important feature for industrial ice cream is the long shelf life (about 1 to 2 years). Throughout the shelf life, the product should maintain high sensory quality. During storage the product must not lose the pleasure of eating effect, which is a very difficult challenge for ice cream products.

Only when the product meets all of the above features, including sensory features, can the frozen product be called ice cream.

In a narrow group of companies producing ice cream desserts using liquid nitrogen—cryogenics, the following can be mentioned: Mini Melts, Dippin Dots, IttyBitz and lce‘n’Go. The above-mentioned companies produce ice cream desserts in the form of ice beads with the use of inorganic ingredients.

Patent application JPH0491749A (published 1992 Mar. 25) describes a method for producing homogeneous and bead-like ice cream, suitable for long-term storage and transport, maintaining stable properties for a long period of time, and the beads are obtained by contacting a drop of ice cream raw material solution with a liquid with very low temperature. The liquid ice cream composition is mixed with the active microorganism and its droplets are directly contacted with a very low temperature liquid such as liquid air, liquid argon, liquid fluorine, liquid hydrogen or liquid nitrogen and converted by freezing to a bead-like state.

The patent application US2002014081A1 (published 2002 Feb. 7) describes a method for modifying a vending machine for storing the product at a temperature not higher than −35° C., moreover, a method for producing and distributing ice cream is presented, thanks to which free-flowing ice cream in the form of beads is produced. The resulting ice cream product is then shipped and distributed through vending machines that are able to maintain the temperature sufficiently low to preserve the beaded and free flowing form of ice cream product. Patent application US2008011009A1 (published 2008 Jan. 17) discloses a device and method for combining particulate and soft serve ice cream. Soft serve ice cream is produced using N2 vapor.

Patent application US2005064074A1 (published 2005 Mar. 24) describes a method and apparatus for combining ice cream beads and cookie dough. The ice cream is transformed into droplets, beaded, frozen, and then combined with the pre-cut shapes of cookie dough. The resulting combination is packaged for subsequent storage at low temperature.

Patent application US2004247747A1 (published 2004 Dec. 9) discloses a frozen product and a method for its preparation, wherein a beaded frozen product is mixed with conventional ice cream. The beaded ice cream (or other frozen products) may be mixed with soft serve ice cream for individual serving, or it may be mixed with ice cream produced on a large scale. With regard to individual servings, ice cream beads may be injected into the dispensing nozzle of the ice cream machine. Alternatively, the beaded ice cream may be introduced into a reservoir of soft serve ice cream and mixed through the stirring process. In the case of packaged ice cream, the beaded ice cream may be introduced into a conventional ice cream mixture at a stage of the process where the non-beaded ice cream is still liquid such that the beaded ice cream may be stirred or agitated to mix and disperse relatively uniformly throughout the ice cream product. After final freezing, the ice cream beads, which maintain their beaded shape, will be mixed and suspended throughout the entire ice cream product. Patent application US2007065552A1 (published 2007 Mar. 22) describes a frozen product and a method for its preparation, in which a beaded frozen product is mixed with traditional ice cream. Consequently, the beaded ice cream (or other frozen product) may be mixed with ice cream served on an individual serving basis or with ice cream produced on a large scale. With regard to individual servings, the ice cream beads may be injected at the dispensing nozzle of the machine for dispensing soft serve ice cream. Alternatively, the beaded ice cream may be introduced into a reservoir of soft serve ice cream. Alternatively, the beaded ice cream may be introduced into the container of soft serve ice cream and mixed in the stirring process. After final freezing, the ice cream beads, which retain their beaded form, will be mixed and suspended throughout the entire ice cream product. Patent application WO2009042035A1 (published 2009 Apr. 2) discloses a system and mechanism for forming discrete ice cream units, which uses cryogenically cooled rotating rollers to form ice cream units during the manufacturing process.

Patent application WO2019051058A1 (published 2019 Mar. 14) discloses a particulate frozen dairy product comprising beads which remain free flowing at a temperature of about −12° C. or less. The beads comprise a dairy product selected from the group consisting of frozen pure cream and frozen anhydrous milk fat. The solution comprises also a method for shipping the frozen dairy product. The method comprises cryogenic freezing of pure cream to form a plurality of frozen beads and shipping the frozen beads while maintaining said frozen beads at a temperature below −12° C. such that the frozen beads remain free flowing during transport. In addition, the frozen beads are ideal for shipping, storage and use as they meet packaging and easy dispensing requirements.

The prior art pure cream beads at −12° C. have been developed to facilitate the long-distance transport of fresh cream in large collecting containers, and to enable repackaging and confectioning at the destination. Thanks to the above, there are savings on transportation and logistics, and the frozen fresh cream is packaged and delivered to the consumer's kitchen as fresh cream, which can be used as an addition to dishes. This is the idea behind the prior art solution from WO2019051058A1, pure cream cryogenic beads at −12° C.

Patent application WO2013002783A1 (published 2013 Jan. 3) discloses a composition comprising a powder coated particulate ice cream product, wherein the particulate ice cream product is cryogenically formed. The particulate ice cream product may further comprise multiple coatings, including one or more powder coatings. The solution further relates to methods for coating these cryogenically frozen ice cream particles. Patent application P.408047 (published 2015 Nov. 9) describes a method for producing edible ice cream, in which after introducing the ice cream ingredients into a container, and before introducing a portion of liquid nitrogen, the mixture is subjected to a foaming process. A portion of the liquid nitrogen is introduced into the so foamed mixture, and then the container is closed with a lid. A portion of the liquid nitrogen is introduced into the foamed mixture, preferably in the form of a single dose. Despite the existing solutions, there is still a great need to develop a natural product. The recipes existing in the prior art are based on inorganic ingredients, which the modern consumer does not accept when seeing them on the label. The products have been unchanged for years and do not follow the trends indicated by the global market. Manufacturers of existing solutions add preservatives, dyes, sweeteners, or unnatural food additives stabilizing the product. Examples of prior art unnatural ingredients in the form of ice beads are, inter alia, glucose—fructose syrup, emulsifier: mono- and diglycerides of fatty acids, dextrose, sucralose. This means that there is a constant need for a solution that would meet all product quality requirements while ensuring the adequate technology.

The products existing in the prior art must be stored at −35° C., which creates a barrier to the development on a larger scale. Ice cream beads existing in the prior art can be stored at −18° C., but they are saturated with chemical additives. By contrast, Eco certified ice cream, which is made from natural ingredients, has a traditional form and is not in the form of beads. In the prior art there are also cryogenic pure cream beads, and they can be stored at temperatures as low as −12° C., but cryogenically frozen pure cream is not an ice cream product because it does not have the sensory properties required for ice cream and ice cream desserts, nor ice cream beads described in the above invention.

Good ice cream is a pleasant cooling sweetness desired by the consumer, leaves the palate with the pleasure of moisturizing like a good skin lotion, leaves a cold feeling on the tongue, and at the same time is soft and creamy, has an inviting form and inviting colors, has an interesting taste, sweetness, and smell. Good ice cream does not melt too quickly, it leaves the feeling of depth on the tongue for a distinctly long period of time. After thawing, the emulsion will not undergo phase separation. It can be stored for up to 2 years, during which the product will still maintain its sensory properties.

There is ice cream available on the market that:
has BIO organic certificate and is natural, but does not have the form of separate beads or beads embedded in a homogeneous traditional ice cream,
is in the form of ice cream beads and ice cream beads embedded in a homogeneous traditional ice cream, but it is not BIO organic certified and is not natural,
is in the form of beads at −18° C., but it is not BIG organic certified and is not natural.

The aim of the invention was to develop a beaded product shock-frozen in liquid gases used for cryogenics in a temperature range from −140° C. to −280° C., adapted to typical cold chains at −10° C. to −18° C. and below and cryogenic, natural ice cream beads embedded in a homogenous, natural, low-aerated traditional ice cream, which product can be marketed on a large scale. Moreover, the aim of the invention was to create a natural stabilizer. The aim of the invention was also to develop a method for producing a frozen food product as well as a Sieve System that made it possible to obtain an innovative product.

Typically, from 0.2 to 25% of an ice cream mixture is a stabilizer, the components of which are stabilizing, emulsifying and/or sweetening ingredients. Excessive use of a stabilizer leads to a condition commonly known as gumminess, in which the product does not melt quickly enough in the mouth, does not have a creaminess, but is perceived as a gummy, chewy emulsion.

The problem existing so far was also the stabilizers available on the market.

Ice cream stabilizers are substances that despite the low level of use in ice cream mixtures, perform very important functions, such as increasing the viscosity of the ice cream mixture, giving smoothness and creaminess, binding water, protecting against phase separation of the ice cream after thawing, or the function of melting control. Slow melting and long-lasting preservation of the original shape are important parameters of the quality of ice cream beads. Stabilizers significantly affect the melting rate of ice cream through their properties of increasing viscosity—as the viscosity increases, the melting rate of ice cream slows down significantly. Correctly stabilized ice cream creates smaller ice crystals at the very beginning of the freezing step, which in turn significantly reduces the accumulation of ice crystals overtime and maintains a pleasant, smooth texture. During storage, unfrozen water participates in the recrystallization process. Stabilizers are used to control the size of the ice crystals acting in two ways: by binding water, and thereby reducing the amount of water available during storage; and by increasing the viscosity of the surface phase surrounding the ice crystals, and thereby reducing the diffusion rate and slowing down the recrystallization process.

A good ice cream stabilizer is a composition of an optimally selected amount of individual hydrocolloids, such that they create an ideal stabilizing mixture when acting in synergy.

The natural stabilizer used for ice cream beads according to the invention at −10° C. to −18° C. effectively reduces the occurrence of unfavorable changes during the storage of the product at −10° C. to −18° C. The higher temperature during storage and distribution compared to the previously required temperature of −35° C. has led to a change in the technological process of ice cream bead formation in the bath of liquid gases used for cryogenics (e.g. in liquid nitrogen).

During storage, continuous processes take place which reduce the quality of the product. As the temperature rises, the processes accelerate significantly and lead to the sticking of the beads. The above process is unfavorable for the product, the distinguishing feature of which are frozen, creamy, free flowing beads, that rattle in the package.

The inventors created the first in the world natural stabilizer from natural ingredients, after using of which the previous taste qualities of the product were maintained, and at the same time the ice cream bead was improved and adapted for storage at −10° C. to −18° C. The ice cream beads obtained according to the invention at −10° C. to −18° C. are still free-flowing, hard, cold (cold feeling on the tongue, as previously known ice cream beads stored at temperatures below −35° C.), tasty and creamy, pleasant to eat.

The uniqueness of the natural stabilizer according to the invention is the formula of the used ingredients, which interact with each other and, with appropriately used proportions, enhance their functions, and with improper use of proportions, they suppress their functions. The proper, obtained natural stabilizer means dozens of costly tests in the laboratory, then on the production line and storage tests. According to the invention, the natural stabilizer is used to stabilize the process of droplets formation and shock freezing of ice cream beads in a bath of liquid gases used for cryogenics and to stabilize the product (its sensory properties); to stabilize and, as a result to limit the unfavorable phenomena occurring during the storage of the product at a temperature of −10° C. to −18° C., the intensity of which is many times greater than that of the phenomena occurring during storage at a temperature below −35° C. The designed by the inventors natural stabilizer for ice cream beads and beads embedded in traditional ice cream at −10° C. to −18° C. consists of ingredients available in nature, BIO certified or non-BIG certified ingredients.

As a result of many years of research and tests, the authors of the solution have understood the processes taking place during emulsification, hydration of the ingredients of the ice cream mixture, shock freezing, aging, packaging of the product and its storage. Understanding the physical phenomena led the inventors to create a new product, natural ice cream beads, adapted to traditional cold chains at −10° C. to −18° C., which is the first and only product in the world with such a unique solution.

Implementation of a such defined goal and the solution of the problems described in the prior art related to the development and delivery of the invention enabling the creation of a “as before” tasty and healthy product without the use of enhancers was achieved in the present invention. The inventors created a natural, organic and healthy product, while retaining the form of beads.

The most important feature and trend for ice cream in the world is to meet the taste expectations and the pleasure of eating for the consumer. According to the present invention, the cryogenic ice cream beads and the cryogenic ice cream beads embedded in a homogeneous traditional ice cream are primarily tasty, made from natural certified or non-certified organic ingredients, and we can divide them into the following categories:
category I.A.—milk ice cream beads—the ice cream base is: fresh cream (cream from animal milk, i.e. cow, goat, buffalo, sheep, camel, horse, etc.), natural stabilizer;
category I.B.—PROBIOTIC—milk ice cream beads—the ice cream base is: fresh cream (cream from animal milk, i.e.: cow, buffalo, sheep, camel, horse, etc.), natural stabilizer, live bacteria cultures;
category II.A.—vegan ice cream beads—the ice cream base is: vegetable drink (rice, almond, soy, oat, coconut “milk”, etc.), vegetable oil (olive, rapeseed, sunflower, etc.), natural stabilizer;
category II.B.—PROBIOTIC—vegan ice cream beads—the ice base is: vegetable drink (rice, almond, soy, oat, coconut “milk”, etc.), vegetable oil (olive, rapeseed, sunflower, etc.), natural stabilizer, live bacteria cultures;
category III.A.—fruit juice ice cream—the ice cream base is: fruit juices, natural stabilizer; category III.B.—PROBIOTIC—fruit juice ice cream—the ice cream base is: fruit juices, natural stabilizer, live bacteria cultures;
category IV.A.—black coffee in the form of ice cream beads—the ice cream base is: cold brew coffee, natural stabilizer;
category IV.B.—PROBIOTIC—black coffee in the form of ice cream beads—the ice cream base is: cold brew coffee, natural stabilizer, live bacteria cultures;
category V.A.—water ice beads—the ice cream base is: water, natural stabilizer;
category V.B.—PROBIOTIC—water ice beads—the ice cream base is: water, natural stabilizer, live bacteria cultures.

The above ice cream beads can be stored at temperatures from −10° C. to −18° C. and below.

The inventors created Product 1 in the form of ice cream beads, taking into account the existing limitations, i.e. the product consists of natural ingredients. All products may have BIO certificates granted for products in accordance with EU Regulation 889/2008, Annex VIII. The food product is adapted to the typical cold chains for a temperature −10° C. to −18° C.; it has the form of small beads with a diameter of 1 mm to 9 mm.

Due to the above features, the product according to the invention is the first and only such product in the world. The same is in the case of preparation of Product 2, ice cream beads embedded in a homogeneous traditional ice cream with the above-mentioned properties.

The present invention relates to a frozen food product in the form of shock-frozen ice cream beads, characterized in that the product it is in the form of ice cream beads with a diameter of 1 mm to 9 mm stabilized with a natural stabilizer, wherein the finished ice cream mass is subjected to dripping and formation of droplets, and then shock freezing and it is frozen in the temperature range of −140° C. to −280° C., and the obtained beaded food product is suitable for storage in cold chains with a temperature of −10° C. to −18° C., and wherein the percentage of the natural stabilizer is up to 25% of the total weight of the ice cream mixture, and wherein the natural stabilizer includes inulin, sweeteners and egg yolk, wherein sweeteners, including sugar, are in the range of 0-9%, egg yolk is in the range of 0-2%, inulin is in the range of 4-12%, and wherein the fat content of the ice cream mass is between 0 and 16%.

Preferably, the natural stabilizer comprises sweeteners selected from sugar or sweeteners selected from xylitol, inulin, steviol glycosides, erythritol, monk fruit, and further comprises egg yolk, lecithin, carrageenan, guar gum, xanthan gum, gum arabic and/or locust bean gum, the content of sweeteners being in the range of 0 to 9%, preferably 0 to 5%.

Preferably, the natural stabilizer is introduced before the step of dripping of the ice cream mass and beads formation.

Preferably, there is no more than 250 g of natural stabilizer together with sweeteners per kilogram of ice cream mass.

Preferably, the natural stabilizer further comprises sweeteners and/or thickeners.

Preferably, the product further comprises food colorants and/or flavors and it further comprises a fruit batch. Preferably it further comprises a cream selected from cow, goat, buffalo, sheep, camel and/or horse milk and/or a dairy product from cow, goat, buffalo, sheep, camel and/or horse milk, the dairy product containing or not lactose and/or vegetable drink and/or fruit juice and/or cocoa and/or coffee.

Preferably, the product further comprises probiotic live bacteria cultures.

Preferably it further comprises spirulina.

Preferably, the product is a vegan product and comprise vegetable fats, the oil content of the ice cream mass being between 0 and 16%.

Preferably, it is a product consisting only of fruit juice and a natural stabilizer. Preferably, the cryogenically frozen beads are embedded in a homogeneous traditional ice cream.

Another object of the invention is a natural stabilizer for a frozen food product, characterized in that it comprises inulin, sweeteners and egg yolk, and wherein the percentage of the natural stabilizer is up to 25% of the total weight of the ice cream mixture, sweeteners, including sugar, are in the range of 0-9%, egg yolk is in the range of 0-2%, inulin is in the range of 4-12%.

Preferably, the sugar or sweeteners are selected from sugar from sugar beet, sugar from sugar cane, xylitol, inulin, steviol glycosides, erythritol, monk fruit, the sweeteners content being in the range of 0 to 9%, preferably 0 to 5%.

Preferably, the natural stabilizer further comprises carrageenan, guar gum, xanthan gum, gum arabic, locust bean gum, pectin and/or lecithin.

Preferably, the percentage of ingredients relating to the total weight of the ice cream mixture containing the natural stabilizer includes lecithin in the range of 0-2%, the carrageenan content of 0-0.3%, guar gum in the range of 0-0.1%, xanthan gum in the range 0-0.1%, gum arabic in the range of 0-0.1%, locust bean gum in the range of 0-0.1%, pectin in the range of 0-0.2%, steviol glycosides in the range of 0-0.3%, erythritol in the range of 0-11%, monk fruit in the range of 0-0.4%.

Preferably, all ingredients are of natural origin and have or do not have BIO certificates.

Another object of the invention is a method for producing a frozen food product as defined above, characterized in that the following steps are carried out sequentially:
a) adding a natural stabilizer to the ice cream base with a fat content of 0 to 16% and a temperature of +4 to +90° C.;
b) emulsifying and/or hydrating the components of the ice cream mixture at the temperature of +2 to +8° C. for at least 3 hours;
c) including or not including coloring foods and/or food colorants, fruit concentrates and/or flavors into the ice cream mass;
d) dripping of ice cream mass and formation of droplets on a Sieve System that includes from 1 to 6 Sieve Sets; One Set of Sieves consists of a Proper sieve and 0 to 3 Auxiliary sieves, the Sieve System accelerates the ice cream beads production process from 300 to 1500 kg per hour, and the Auxiliary sieves dissipate the energy of the ice cream mass;
e) formation of droplets of ice cream mass on a Sieve System and subjecting them to shock freezing in liquid gases used in cryogenics in the temperature range from −140° C. to −280° C.;
f) Packing the frozen ice cream beads in airtight packages;
g) storage in freezers with a temperature in the range of −10° C. to −18° C. and below.

Preferably, step c) is followed by introducing probiotic live bacteria cultures in an amount of 108 to 101° CFU/g. Preferably, in the droplets formation step (e) of the ice cream mass a natural stabilizer is used to stabilize the production process of beads formation in a bath of liquid gases used in cryogenics in a temperature range from −140° C. to −280° C. and to stabilize the product, including its sensory properties and/or to stabilize the product during storage at −10° C. to −18° C.

Preferably step (e) is additionally followed by the step of mixing the ice cream beads into the traditional ice cream mass.

Another object of the invention is a Sieve System for forming ice cream beads of shock frozen food products as defined above, characterized in that the Sieve System includes a Sieve Set, wherein the Sieve Sets include a Proper sieve and from 0 to 3 Auxiliary sieves.

Preferably, the system includes Proper sieves and Auxiliary sieves, wherein the Proper sieves includes from 1 to 6 Proper sieves, and the Auxiliary sieves include from 0 to 18 Auxiliary sieves, and wherein the diameter of the holes in the sieves is not more than 3 mm and not less than 0.6 mm.

Preferably, one Sieve Set includes a Proper sieve and 0 to 3 Auxiliary sieves, and the Sieve System as a whole includes from 1 to 6 Proper sieves that accelerate the ice cream beads production process from 300 to 1500 kg per hour, and from 0 to 18 Auxiliary sieves dissipating the energy of the ice cream mass. Preferably, the diameter of the holes in the Proper sieves are in the range of 0.6 to 2 mm, preferably 0.8 to 1.5 mm. Preferably, the diameters of the holes in the Auxiliary sieves are in the range of 1.0 to 3 mm, preferably 1.2 to 2.5 mm.

Preferably, the Proper sieves are the last and lowest sieves (sieve) in the system and work with the laminar flow of the ice cream mixture, where surface tension forces dominate, and where the velocity of the ice cream mixture tends to 0 m/s.

Preferably, the Auxiliary sieves serve to dissipate the energy of the ice cream mixture stream and operate at ice cream mixture flow rates greater than the Proper sieves and reach velocity of up to 20 m/s.

The attached figures allow better understanding of the essence of the invention:

FIG. 1 shows the original Sieve System consisting of 6 Sieve Sets, with 6 Proper sieves and 18 Auxiliary sieves.

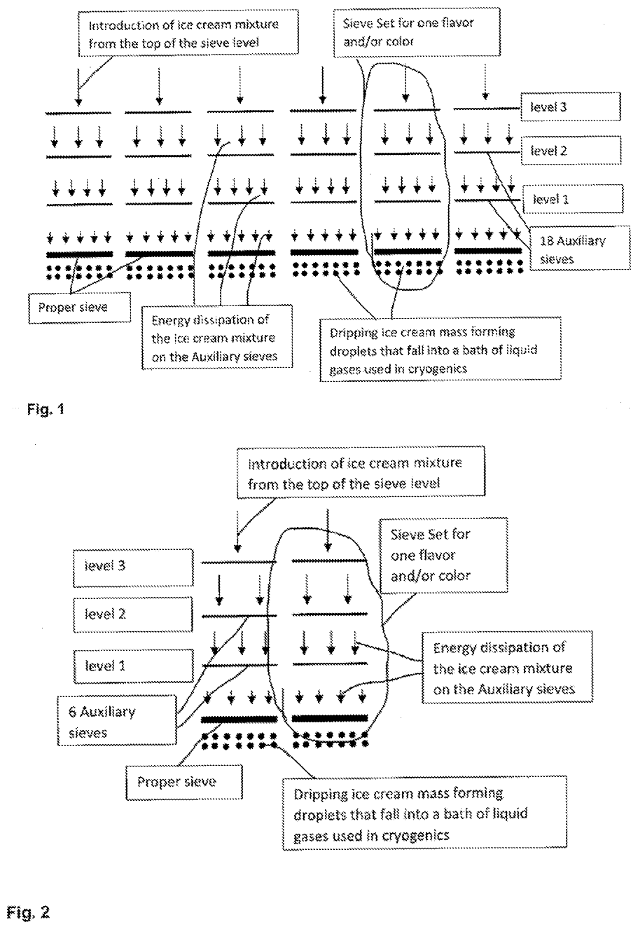

FIG. 2 shows the original Sieve System consisting of 2 Sieve Sets, with 2 Proper sieves and 6 Auxiliary sieves.

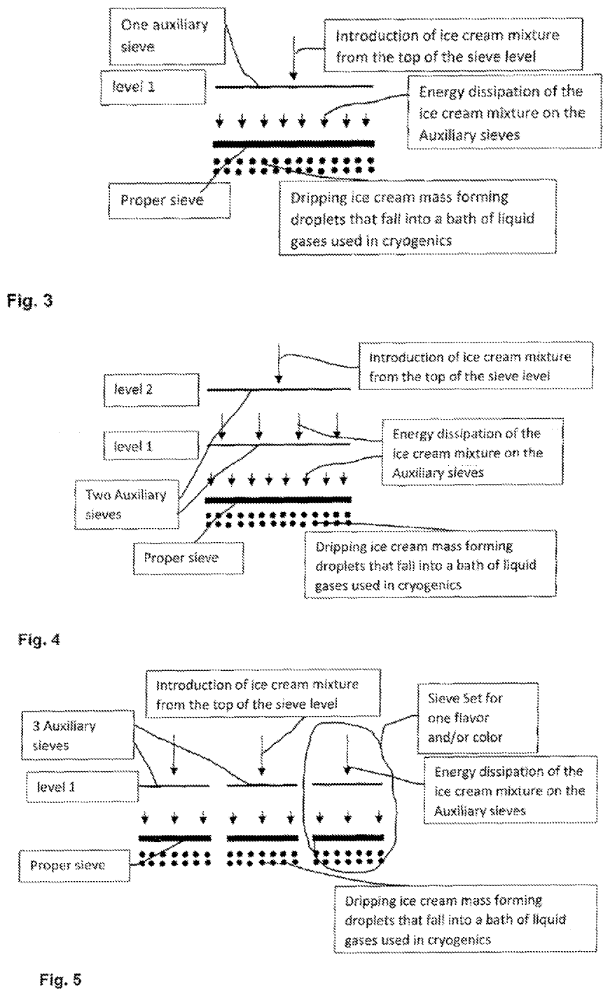

FIG. 3 shows the original Sieve System consisting of 1 Sieve Set, with 1 Proper sieve and 1 Auxiliary sieve.

FIG. 4 shows the original Sieve System consisting of 1 Sieve Set, with 1 Proper sieve and 2 Auxiliary sieves.

FIG. 5 shows the original Sieve System consisting of 3 Sieve Sets, with 3 Proper sieves and 3 Auxiliary sieves.

### DEFINITIONS AND CONCEPTS

The term ice cream used in the patent description may be used interchangeably with the terms: ice, ice cream dessert, ice beads, ice cream beads, food product. Good ice cream is a pleasant, cooling, cold sweetness desired by the consumer, it leaves the palate with the pleasure of moisturizing like a good skin lotion, it leaves a cold feeling on the tongue, and at the same time it is soft and creamy, has an inviting form and inviting colors, has an interesting taste, sweetness and flavor. Good ice cream does not melt too quickly, it leaves feeling of depth on the tongue for a distinctly long period of time. After thawing, the ice cream emulsion does not undergo the process of phase separation and can be stored for up to 2 years, during which time the food product will still maintain its sensory properties. The conscious consumer expectations regarding ice cream and ice cream desserts are very high, they also relate to the origin and quality of the ingredients used to create the food product. A frozen cream mass (e.g. pure cream) without the addition of stabilizing substances, sweeteners, colorants and flavors does not have the above features. Creating ice cream means choosing the right composition in the right proportions of ingredients and its skillful freezing, thanks to which it is possible to achieve interesting forms (e.g. ice beads) using the latest scientific achievements, the state of knowledge relating to the freezing of food products.

As used in the patent description, the term “stabilizer” means a stabilizer commonly used in the literature and refers to typical stabilizers used in the ice cream industry.

As used in the patent description, the term “natural stabilizer” is understood to mean natural stabilizers designed by the inventors, which may comprise a composition of ingredients in various configurations and which are added to the base of the ice cream mixture. A properly selected composition of ingredients allows to achieve all the expected sensory features of ice cream and also improves the ice cream beads so that they can be stored in typical cold chains from −10° C. to −18° C. According to the invention, natural stabilizers are designed from ingredients commonly available on the market, such as: sugar from sugar beet, sugar from sugarcane, xylitol, pasteurized egg yolk or fresh egg yolks, lecithin, inulin, carrageenan, guar gum, xanthan gum, gum arabic, locust bean gum, pectin, steviol glycosides, erythritol, monk fruit. The natural stabilizer is selected according to the used ice cream base and it is the ice cream base that determines which ingredients of the natural stabilizer will be used.

As used in the patent description, the term cryogenics means shock freezing of the droplets of ice cream mass on the Sieve System in a bath of liquefied gases which boiling point is in the range of −140° C. and −280° C.

As used in the patent description, the term shock freezing means quick freezing of an ice product at temperatures ranging between −140° C. and −280° C. Liquid nitrogen is used in the examples, but other gases used in the food industry may also be used.

As used in the patent description, the term cream means the cream of animal milk, such as cow, goat, buffalo, sheep, camel, horse, etc.

As used in the patent description, the term dairy products means products made from animal milk, such as: cow, buffalo, goat, sheep, camel, horse, etc.

As used in the patent description, the term vegetable drink means vegetable drinks commonly referred to as “vegetable milk”, e.g., rice, almond, soy, oat, coconut, hemp, etc.

As used in the patent description, the term vegetable oil means vegetable oil of i.e., olive, rapeseed, sunflower, etc.

As used in the patent description, the term ice cream base includes a natural stabilizer in combination with the main ingredient; for milk ice cream, it will be fresh cream; for vegan ice cream—a vegetable drink (“vegetable milk)” and vegetable oil; for fruit juice ice cream—fruit juice; for ice cream made from coffee in the form of ice beads—cold brew coffee; for water ice beads—water. When the coloring foods and/or natural food colorants, fruit concentrates and/or flavors are introduced or are not introduced into the ice cream base, a range of endless flavors and shades of colors is created, while when living probiotic bacteria cultures are mixed in, the food product according to the invention becomes a food category containing live bacterial cultures and/or probiotic functional food.

As used in the patent description, the term Sieve System refers to a comprehensive system that consists of 1 to 6 Sieve Sets, illustrated in FIGS. 1 to 5, which serves to form ice cream mass droplets. The Sieve System has from 1 to 6 Proper sieves and from 0 to 18 Auxiliary sieves illustrated in FIGS. 1 to 5. The Proper sieve is one of the sieves in the Sieve System and it is used to form droplets of the ice cream mass. In a special case, the Proper sieve can be installed independently without the Auxiliary sieves.

The Auxiliary sieve is the sieve used to dissipate the energy of ice cream mixture. The Auxiliary sieves are arranged in levels, up to 3 levels as illustrated in FIGS. 1 to 5. The mixture is always poured onto the highest level of the Auxiliary sieves, if used, and then the ice cream mixture gravitationally flows through the successive levels of the Auxiliary sieves, losing energy in the process, to uniformly reach the holes in the Proper sieve with energy approaching to 0 m/s.

The Sieve Set is used to form droplets from the prepared ice cream mixture, which shock-frozen in a bath of liquid gases used in cryogenics (e.g. liquid nitrogen) become beads of ice cream, the boiling point of liquid gases is in the range of −140° C. to −280° C. The Sieve Set consists of a Proper sieve, on which the ice cream mass is dripping, and from 0 to 3 Auxiliary sieves, which serve to dissipate the energy of the ice cream mass, which is fed on the highest level of the sieves illustrated in FIGS. 1 to 5.

In order to better understand the invention, the solution is illustrated in the following embodiments. These examples are not intended to limit the invention, but merely allow a more precise understanding of its possible implementations.

### EXAMPLES

Product 1.

Cryogenic ice cream beads at −18° C.

All ingredients constituting the ice cream mixture can be BIO certified ingredients in accordance with EU Regulation 889/2008 Annex VIII and are natural ingredients.

The composition of the mixture varies depending on one of the five categories as above.

All the bulk products that are used for the ice cream mixtures are weighed and mixed in the bulk product mixing plant according to the recipe of the invention. Powdered hydrocolloids are responsible for the gelling and water-binding features in the ice cream mixture, they are stabilizing substances that constitute the Natural Stabilizer used to stabilize the cryogenic ice cream beads.

In the dry products mixing plant the Natural Stabilizer is weighed, added and mixed with inulin, sweeteners and egg yolk, or lecithin, for five categories respectively.

All the ingredients of the natural stabilizer are natural ingredients available on the market.

The natural stabilizer for ice cream beads according to the invention is prepared by mixing dry ingredients in a mixing plant. All components of the natural stabilizer are natural and may have BIO certificate (according to EU Regulation 889/2008 Annex VIII). In the mixing plant, all dry ingredients are weighed and then mixed together.

The examples were made in two variants:
with the use of BIO products, and
with the use of conventional products.

Therefore, it should be noted that where BIO products are used, it will be also possible to use products without BIO certificates.

The same applies to natural products—they can be both 100% natural with and without certificate.

### Example 1

Examples of category I.A.—ice cream base made from fresh cream (cream from milk of: cow, goat, buffalo, sheep, camel, horse, etc.) and a Natural Stabilizer. After the addition of coloring foods and/or natural food colorants, fruit concentrates and/or flavors to the ice cream base, a range of endless flavors and color shades is created.

### Example 1.1.1.—Sweet Cream Ice Cream Beads (Ice Cream Base)

BIO fresh cream (from sheep milk) with a fat content of 13%-83.31%,
BIO Natural Stabilizer—16.69%,

The percentage of the ingredients of the Natural Stabilizer in the ice cream base:
BIO sugar from sugar cane—2.1%, BIO Erythritol—4.5%, Xanthan gum—0.04%,
BIO chicken egg yolk—0.5%, BIO Stevia—0.14%, BIO Guar gum—0.03%,
BIO inulin—9.25%, Carrageenan—0.09%, Monk fruit—0.04%.

### Example 1.1.2.—Candy Floss Flavored Ice Cream Beads

To the ice cream base (Example 1.1.1.) we introduce:
BIO coloring foods Flavors:
(fruit and vegetable concentrates): Candy floss flavor—0.38%.
Red (radish, apple, black currant)—0.3%,
Yellow (pumpkin, apple)—0.25%,
Yellow (carrot, apple)—0.2%,

### Example 1.2.1.—Sweet Cream Ice Cream Beads (Ice Cream Base)

Fresh cream (from camel milk) with a fat content of 6%-80.01%,
Natural Stabilizer—19.99%,

The percentage of the ingredients of the Natural Stabilizer in the ice cream base:
Pasteurized duck egg yolk—0.45%, Erythritol-6.7%, Carrageenan—0.16%.
Steviol glycosides—0.09%, Monk fruit—0.04%, Inulin—8.5%,

### Example 1.2.2.—Gummy Berry Flavored Ice Cream Beads

To the ice cream base (Example 1.2.1.) we introduce:

Coloring foods Flavors:
(fruit and vegetable concentrates): Gummy Berry Flavor—0.37%.

Purple plum (carrot, blueberry)—0.13%,

### Example 1.2.3.—Mint-Flavored Ice Cream

To the ice cream base (Example 1.2.1.) we introduce:

Natural colorant Flavors:
Spirulina —0.11%, Mint flavor—0.28%.

### Example 1.3.1.—Sweet Cream Ice Cream Beads (Ice Cream Base), (FIG. 3)

BIO fresh cream without lactose (from cow milk) with a fat content of 13%-83.72%,
BIO Natural Stabilizer—1 6.28%,

The percentage of the ingredients of the Natural Stabilizer in the ice cream base:
BIO sugar from sugar beet—3.49%, BIO Erythritol—5.23%, BIO Guar gum—0.02%,
BIO Pasteurized egg yolk—0.35%, BIO Stevia —0.08%, Xanthan gum—0.01%.
BIO agave inulin—6.97%, Carrageenan—0.13%,

### Example 1.3.2.—Strawberry-Flavored Ice Cream Beads

To the ice cream base (Example 1.3.1.) we introduce:
BIO coloring foods Flavors:
(fruit and vegetable concentrates): Strawberry flavor—0.4%.
Red (carrot, apple, black currant)—0.2%,

### Example 1.4.1.—Sweet Cream Ice Cream Beads (Ice Cream Base)

Fresh cream without lactose (from buffalo milk) with a fat content of 16%-82.61%,
Natural Stabilizer—17.39%,

The percentage of the ingredients of the Natural Stabilizer in the ice cream base:
Pasteurized egg yolk—0.45%, Erythritol—8.15%, Carrageenan—0.16%
Agave inulin—8.5%, Stevia —0.12%, Xanthan gum—0.01%.

### Example 1.4.2.—Banana-Flavored Ice Cream Beads

To the ice cream base (Example 1.4.1.) we introduce:
Food colorants Flavors:
Yellow—0.38%, Banana flavor—0.36%.

### Example 1.5.1. Sweet Cream Ice Cream Beads (Ice Cream Base)

BIO fresh cream without lactose (from goat milk) with a fat content of 8%-83.38%,
BIO Natural Stabilizer—16.62%,

The percentage of the ingredients of the Natural Stabilizer in the ice cream base:
BIO pasteurized duck egg yolk—0.4%, BIO inulin—8.1%, Carrageenan—0.15%,
BIO steviol glycosides—0.07%, BIO Erythritol—7.75%, BIO Guar gum—0.01%.

### Example 1.5.2.—Chocolate Ice Cream Beads (Suitable for Storage at a Temperature Below −12° C.)

To the ice cream base (Example 1.5.1.) we introduce:
BIG cocoa—4.1%.

### Example 1.6.1. Sweet Cream Ice Cream Beads (Ice Cream Base)

Fresh cream without lactose (from horse milk) with a fat content of 16%-83.38%,
Natural Stabilizer—16.62%,

The percentage of the ingredients of the Natural Stabilizer in the ice cream base:
Pasteurized egg yolk—0.6%, Erythritol—6.1%, Steviol glycosides—0.12%.
Inulin—9.8%,

### Example 1.6.2—Bubble Gum Flavored Ice Cream Beads (FIG. 1)

To the ice cream base (Example 1.6.1.) we introduce:
Coloring foods (fruit and vegetable concentrates):
Pink (beetroot, carrot)—0.3%, Yellow (carrot, apple)—0.3%, Blue (spirulina)—0.3%.
Green (spirulina powder)—0.11%, Yellow (pumpkin, apple)—0.32%,

Flavors:
Bubble gum flavor—0.39%.

### Example 2

Examples of category II.A.—from the vegetable drink “milk” (rice, almond, soy, oat, coconut, etc.), vegetable oil (olive, rapeseed, sunflower, etc.) and the Natural Stabilizer an ice cream base is made, which after adding coloring foods and/or natural food colorants, fruit concentrates and/or flavors results in a range of endless flavors and color shades.

### Example 2.1.1.—Vegan Sweet Cream Ice Cream Beads (Ice Cream Base)

BIO vegetable drink rice “milk”—73.37%, BIO olive oil—11.0%, BIO Natural Stabilizer −15.63%. The percentage of the ingredients of the Natural Stabilizer in the ice cream base:
BIO sugar from sugar beet—3.1%, BIO Erythritol—3.3%, Carrageenan—0.09%,
BIO agave inulin—8.1%, BIO pectin—0.15%, BIO Guar gum—0.01%,
BIO steviol glycosides—0.07%, BIO lecithin—0.8%, Xanthan gum—0.01%.

### Example 2.1.2.—Vegan Vanilla Flavored Ice Cream Beads

To the ice cream base (Example 2.1.1.) we introduce:
BIO coloring foods Flavors:
(fruit and vegetable concentrates): Vanilla flavor—0.37%.
Yellow (pumpkin, apple)—0.2%,

### Example 2.2.1.—Vegan Sweet Cream Ice Cream Beads (Ice Cream Base)

BIO vegetable drink almond “milk”—68.89%, BIO sunflower oil—7.0%, BIO rapeseed oil—6.0%, BIO Natural Stabilizer—18.11%,

The percentage of the ingredients of the Natural Stabilizer in the ice cream base:
BIO lecithin—0.9%, BIO pectin—Orll %, Carrageenan—0.12%,
BIO inulin—9.3%, BIO stevia —0.15%, BIO Guar gum—0.03%.
BIO Erythritol—7.5%,

### Example 2.2.2.—Candy Floss Flavored Ice Cream Beads (FIG. 2)

To the ice cream base (Example 2.2.1.) we introduce:

BIO coloring foods Flavors:
(fruit and vegetable concentrates): Candy floss flavor—0.42%.
Red (radish, apple, black currant)—0.4%,
Yellow (pumpkin, apple)—0.3%,
Yellow (carrot, apple)—0.25%,

### Example 3

Examples of category III. A.—ice cream beads made from fruit juices and a Natural Stabilizer.

### Example 3.1.—Fruit Ice Cream Beads from Fruit Juices—Orange

BIO orange juice—83.04%, BIO Natural Stabilizer—16.96%,

The percentage of the ingredients of the Natural Stabilizer in the ice cream base:
BIO sugar from sugar cane—1.5%, BIO pectin—0.13%, Carrageenan—0.11%,
BIO inulin—8.7%, BIO stevia —0.14%, BIO Guar gum—0.02%,
BIO Erythritol—6.3%, Xanthan gum—0.01%.

### Example 3.2.—Fruit Ice Cream Beads from Fruit Juices—Pineapple

Pineapple juice—82.63%, Natural Stabilizer—17.37%,

The percentage of the ingredients of the Natural Stabilizer in the ice cream base:
Inulin—9.4%, Pectin—0.17%, Carrageenan—0.15%,
Erythritol—7.5%, Monk Fruit—0.14%, Guar gum—0.01%.

### Example 4

### Examples of Category IV.A.—Ice Cream Beads Made from Cold Brew Coffee and a Natural Stabilizer

### Example 4.1.—Coffee Ice Cream Beads

BIG cold brew coffee—86.1%, BIG Natural Stabilizer—13.9%,

The percentage of the ingredients of the Natural Stabilizer in the ice cream base:
BIO sugar from sugar cane—1.2%, BIO Erythritol—4.5%, Carrageenan—0.13%,
BIO inulin—7.9%, BIO stevia —0.08%, BIO Guar gum—0.01%,
Xanthan gum—0.03%.

### Example 4.2.—Coffee Ice Cream Beads

Cold brew coffee—90.74%, Natural Stabilizer—9.26%,

The percentage of the ingredients of the Natural Stabilizer in the ice cream base:
Inulin—9.1%, Carrageenan—0.15%, Guar gum—0.01%.

### Example 5

Examples of category V.A.—ice cream mixture consisting of water and a Natural Stabilizer.

### Example 5.1.—Cola-Flavored Ice Cream Beads

Water—84.98%, BIO Natural Stabilizer—15.02%,

The percentage of the ingredients of the Natural Stabilizer in the ice cream base:
BIO Xylitol—1.5%, BIO Erythritol—5.5%, Carrageenan—0.12%,
BIO inulin—7.8%, BIO steviol glycosides—0.07%, BIO Guar gum—0.02%,
Xanthan gum—0.01%.

Flavors:
Cola flavor—0.45%.

Example 5.2.—orangeade flavored ice cream beads (adapted to be stored at a temperature below −10° C.) Water—82.31%, Natural Stabilizer—17.69%,

The percentage of the ingredients of the Natural Stabilizer in the ice cream base:
Inulin—8.1%, Xanthan gum—0.01%, Carrageenan—0.14%,
Erythritol—9.2%, Acacia gum—0.03%, Guar gum—0.03%.
Stevia—0.07%, Pectin—0.11%,

Flavors:
Orangeade flavor—0.06%.

### Example 5.3.—Fruit Ice Cream Beads

Water—82.14%, Natural Stabilizer—17.86%,

The percentage of the ingredients of the Natural Stabilizer in the ice cream base:
Inulin—9.5%, Xanthan gum—0.03%, Carrageenan—0.15%,
Erythritol—6.7%, Pectin—0.13%, Guar gum—0.02%.
Stevia—0.13%,

Food Colorants: Flavors: Fruit batch:
Colorants—0.1% to 0.3%, Flavor—from 0.05% to 0.4%, Strawberry concentrate—0.0 to 10.0%.

Examples of categories from I.B. to V.B.—PROBIOTIC ice cream beads—after introducing into the prepared ice cream mixture (containing an ice cream base and containing/or not containing coloring foods and/or natural food colorants, flavors) probiotic live bacteria cultures in an amount of 108 to 1010 CFU/g, which will guarantee survival at a level of above 106 CFU/g throughout the period of the declared shelf life of the product, the above food products from categories I.A. to V.A., after admixing live probiotic bacterial cultures, become a category of food containing live bacteria and/or probiotic functional food.

### Example 6

The method for preparing ice cream

The main ingredient of the ice cream beads according to the invention is:
category I.A. and I.B.—milk ice cream beads—fresh cream made from animal milk with or without BIO certificate (cow, goat, buffalo, sheep, camel, horse, etc.) with a fat content from 3% to 16%;
category II.A. and II.B.—vegan ice cream beads—vegetable drink with or without BIO certificate (rice, almond, soy, oat, coconut milk, etc.) and vegetable oil with or without BIO certificate (olive, rapeseed, sunflower, etc.) in the amount from 4.0% to 14.0%;
category III.A. and III.B.—fruit juice ice cream beads—fruit juices with or without BIO certificate;
category IV.A. and IV.B.—coffee in the form of ice cream beads—cold brew coffee with or without BIO certificate;
category V.A. and V.B.—water ice cream beads—water.

To the main ingredient of the ice cream mixture (I.—fresh cream made from milk (cow, goat, buffalo, sheep, camel, horse) with or without BIO certificate, II.—BIO vegetable drink (rice, almond, soy, oat, coconut “milk”, etc.); III.—fresh fruit juice with or without BIO certificate; IV. —cold brew coffee with or without BIO certificate; V.—water) at a temperature ranging from +4 to +90° C., we introduce the natural stabilizer with or without BIO certificate according to the invention.

The natural stabilizer is introduced into the ice cream mixture using industrial blenders or a typical industrial production line for traditional ice cream.

After introducing the natural stabilizer of the invention into the ice cream mix, a mixture is formed, which emulsifies and/or hydrates the ingredients of the natural stabilizer for at least 3 hours at a temperature of +2 to +8° C., so that all the ingredients are emulsified and/or hydrated and the resulting ice cream mass is an uniform smooth emulsion.

In the last phase, immediately before freezing, natural coloring foods and/or food colorants, fruit concentrates and/or flavors (in accordance or not in accordance with EU Regulation 889/2008 Annex VIII), and optionally probiotic live bacteria cultures are introduced into the finished ice cream mass.

The finished ice cream mass is subjected to dripping, droplets formation and freezing in a bath of liquid gases used for cryogenics (in this case, liquid nitrogen at a temperature of −195.8° C.). At this stage, the used natural stabilizer stabilizes the production process while performing several functions: it enables the dripping and formation of droplets of ice cream mass on the Sieve System (FIG. 1-5), which after shock freezing in liquid gases used in cryogenics takes the shape of an ice cream beads having 1 to 9 mm; stabilizes the food product (its sensory properties); stabilizes and as a result reduces the unfavorable phenomena occurring during the storage of ice cream beads at a temperature of −10° C. to −18° C.

Storage conditions for bulk components used for ice cream mixtures: Store in a dry place at a temperature from 0 to +25° C. and humidity <75%.

Use conditions: intended for the production of food ice cream beads.

Maximum dosage: 250 g/kg.

Ice cream beads are formed through the process of dripping and droplets formation from the Sieve System designed according to the invention. The processes occurring during the formation of ice cream droplets on the applied Sieve System are highly unstable and difficult to describe with empirical formulas. During the formation of an ice cream bead in the production line, we are dealing with laminar flow of the liquid, turbulent flow of the liquid, determining forces of surface tension and resistance to motion.

The process is very unstable and requires maintaining it in constant equilibrium by experienced staff operating a cryogenic production line for the production of the natural ice cream beads described in the above application, adapted to typical cold chains with a temperature of −10° C. to −18° C.

Ice cream mixture, like any physical body, has certain features that determine its behavior in the production process of ice cream bead formation on the production line. These features are called the physical and chemical properties of the ice cream mixture, which determine and have a great influence on the final shape of the ice cream bead: ice cream mixture density, ice cream mixture viscosity, thermal expansion, and surface tension.

The phenomena that occur on all the sieves of the Sieve System during the formation of the droplets are interdependent, overlapping and influencing each other. The defined process is very difficult to tune, it is very unstable and conditioned.

The designed Sieve System of the invention for natural ice cream beads adapted to typical cold chains with a temperature of −10° C. to −18° C. allows to accelerate the production of ice cream beads up to 1500 kg per hour. A Sieve System consists of 1 to 6 Sieve Sets (FIGS. 1-5), which are individually dedicated to one flavor and/or color. All the sieves in the Sieve System perform its function in the process of creating droplets from ice cream mass and then ice cream beads in a bath of liquid gases used in cryogenics (in this case, liquid nitrogen).

The last and the lowest sieve in the Sieve Set is the Proper sieve (from 1 to 6 Sieve Sets and therefore from 1 to 6 Proper sieves). The Proper sieves of the Sieve System can accelerate the production of beads from 300 to 1500 kg per hour. Proper sieves work with the laminar flow of the ice cream mixture, where the velocity of the ice cream mixture is approaching to 0 m/s, and thereafter the process is determined only by the surface tension forces. The processes taking place on the Proper sieve are highly conditioned, unstable processes. With a slight increase in the flow rate of the ice cream mixture, just over 0 m/s, the forming droplets are irretrievably “damaged” and broken as a result of the occurring surface tension.

Obtaining uniform work on all holes of the Proper sieve, obtaining a constant laminar flow with the velocity approaching to 0 m/s and simultaneously forcing all holes to work is an extremely difficult task. It is difficult to achieve the above-mentioned state of the Proper sieve operation without the Auxiliary sieve system. Auxiliary sieves (from 0 to 3 Auxiliary sieves in one Sieve Set and up to 18 Auxiliary sieves in the entire Sieve System) operate at much higher through-hole flow rates (up to 20 m/s) of the ice cream mixture and are used to dissipate the energy of the ice cream mixture stream.

Frozen ice cream beads are directed to the packaging line, where they are packed and closed in airtight packages with a weight of 50 to 2500 g and are confectioned.

Confectioned ice cream beads can be stored in freezers at temperatures ranging from −10° C. to −18° C. and below.

If the obtained ice cream beads of the invention are compared to similar ice cream beads on the market, then apart from a similar shape and a similar size of the beads, ice cream beads of the invention have no common features with other available ice cream.

Embodiments of the Sieve System for selected ice cream mixtures are presented below.

### Example 7

### Examples of the Use of the Sieve System

The use of the Sieve System for exemplary ice cream mixtures designed in accordance with the invention.

### Example 7.1.—Sieve System—for Example 1.6.2.—Bubble Gum Flavored Ice Cream Beads

In order to form ice cream beads from the ice cream mass in the process of dripping droplets and their shockfreezing in a bath of liquid gases used for cryogenics (e.g. nitrogen) for the above mixture, the Sieve System designed in the scope of the above invention was used, as shown in FIG. 1, consisting of:
1) six Sieve Sets for each of the six colors respectively,
2) six Proper sieves with a mesh diameter of 0.9 mm,
3) eighteen Auxiliary sieves for energy dissipation of the ice cream mixture, six sieves on three levels: level 1 with a mesh diameter of 1.2 mm; level 2 with a mesh diameter of 1.4 mm; level 3 with a mesh diameter of 1.6 mm.

The ice cream mixture having six colors is fed to the uppermost third level of the Auxiliary sieves, to each of the six Sieve Sets. The mixture flows under gravity through successive levels 3, 2, 1 of Auxiliary sieves, dissipating its energy in the process and, consequently, the calmed mixture goes to the Proper sieve, where it drips forming droplets that fall into the bath, where subsequently are shock-frozen in liquid gases used in cryogenics (in this case in nitrogen, at −195.8° C.) and during shock freezing ice cream beads are formed.

### Example 7.2.—Sieve System—for Example 2.2.2.—Candy Floss Flavored Ice Cream Beads

In order to form ice cream beads from the ice cream mass in the process of dripping droplets and their shock-freezing in a liquid nitrogen bath for the above mixture, the Sieve System designed in the scope of the above invention was used, as shown in FIG. 2, consisting of,
1) two Sieve Sets for two colors respectively,
2) two Proper sieves with a mesh diameter of 1.0 mm,
3) six Auxiliary sieves for energy dissipation of the ice cream mixture, two sieves on each three levels: level 1 with a mesh diameter of 1.2 mm; level 2 with a mesh diameter of 1.5 mm; level 3 with a mesh diameter of 1.8 mm.

The ice cream mixture having two colors is fed to the uppermost third level of the Auxiliary sieves, to each of the two Sieve Sets. The mixture flows under gravity through successive levels 3, 2, 1 of Auxiliary sieves, dissipating its energy in the process and, consequently, the calmed mixture goes to the Proper sieve,
where it drips forming droplets that fall into the bath, where subsequently are shock-frozen in liquid nitrogen and ice cream beads are formed.

### Example 7.3.—Sieve System—for Example 1.3.2.—Strawberry Flavored Ice Cream Beads and for Example 5.2.—Orangeade Flavored Ice Cream Beads

In order to form ice cream beads from the ice cream mass in the process of dripping droplets and their shock-freezing in a liquid nitrogen bath for the above mixture, the Sieve System designed in the scope of the above invention was used, as shown in FIG. 3, consisting of:
1) one Sieve Set,
2) one Proper sieve with a mesh diameter of 0.8 mm,
3) one Auxiliary sieve for energy dissipation of ice cream mixture with a mesh diameter of 1.8 mm.

The ice cream mixture is fed to the Auxiliary sieve. The mixture flows under gravity through the Auxiliary sieve, dissipating its energy in the process and, consequently, the calmed ice cream mixture goes to the Proper sieve, where it drips forming droplets that fall into the bath, where are shock-frozen in liquid nitrogen and ice cream beads are formed.

### Example 7.4.—Sieve System—for Example 4.1.—Ice Cream Beads from Coffee

In order to form ice cream beads from the ice cream mass in the process of dripping droplets and their shock-freezing in a liquid nitrogen bath for the above mixture, the Sieve System designed in the scope of the above invention was used, as shown in FIG. 4, consisting of:
1) one Sieve Set,
2) one Proper sieve with a mesh diameter of 1.2 mm,
3) two Auxiliary sieves for energy dissipation of the ice cream mixture, one sieve on each two levels: level 1 with a mesh diameter of 1.4 mm; level 2 with a mesh diameter of 1.7 mm.

The ice cream mixture is fed to the uppermost second level of the Auxiliary sieves. The mixture flows under gravity through successive levels 2, 1 of Auxiliary sieves, dispersing its energy in the process and consequently, the calmed ice cream mixture goes to the Proper sieve, where it drips forming droplets that fall into the bath, where are subsequently shock-frozen and ice cream beads are formed.

### Example 7.5.—Sieve System—for Example 5.3.—Fruit Ice Cream Beads

In order to form ice cream beads from the ice cream mass in the process of dripping droplets and their shock-freezing in a liquid nitrogen bath for the above mixture, the Sieve System designed in the scope of the above invention was used, as shown in FIG. 5, consisting of:
1) three Sieve Sets for the three flavors and colors, respectively,
2) three Proper sieves with a mesh diameter of 1.1 mm,
3) three Auxiliary sieves for energy dissipation of the ice cream mixture with a mesh diameter of 1.7 mm.

The ice cream mixture having three flavors and/or three colors is fed to the Auxiliary sieves, to each of the three Sieve Sets. The mixture flows under gravity through the Auxiliary sieves, dissipating its energy in the process and, consequently, the calmed ice cream mixture goes to the Proper sieves, where it drips forming droplets that fall into the bath, where are subsequently shock-frozen in liquid gases used in cryogenics. Ice cream beads are formed during shock freezing.

Prior art cryogenic products must be stored at −35° C. and below, which creates a barrier to development on a larger scale. The prior art ice cream beads are stored at −18° C., but they are saturated with chemical additives. In contrast, the ice cream, which is made from natural, Eco certified ingredients, has a traditional form and is not in the form of beads.

The ice cream beads according to the invention are:
tasty and sensory tests confirm the high quality of ice cream beads of the invention,
they can be stored at −10° C. to −18° C. and are still hard, cold and creamy, as explained below
high quality creaminess is obtained without the use of commonly used stabilizing ingredients that are not 100% natural and are not certified according to EU regulation 889/2008 Annex VIII relating to the processing of certified organic food.

One of the evaluations is a test that ice cream beads stored at a temperature of −10° C. to −18° C. maintain their sensory characteristics throughout their shelf-life (date on the packaging),
after shaking, they disintegrate and are separate, non-sticky beads that rattle when shaken,
after opening the package, the beads are “dry”, there are no ice crystals on the outside, they remain creamy, and we do not feel ice crystals on the tongue, “we do not feel sand on the tongue”,
the beads maintain their spherical shape for a few minutes at room temperature,
after melting the beads, we obtain a homogeneous ice cream mass, the emulsion is not subject to phase separation.

The capacity of the cryogenic ice cream bead production line according to the invention ranges from 300 to 1500 kg/h.

Product 2

Cryogenic Ice Cream Beads Embedded in a Homogeneous Ice Cream Mass

Product 1—ice cream beads and ice cream beads used for Product 2—i.e. beads embedded in a homogeneous ice cream mass are the same ice cream beads. The only difference is that the ice cream beads in Product 1 are stand alone, and the same ice cream beads in Product 2 are embedded in a traditional homogeneous ice cream.

Examples of ice cream beads that are embedded in a homogeneous traditional ice cream are shown above for Product 1.

The ice cream beads directly shock-frozen in liquid nitrogen (at −195.8° C.) and frozen in a temperature range of −140° C. to −280° C. are directed to a machine that introduces ice cream beads into the traditional ice cream mass directly exiting continuous freezers. The mixed ice cream beads in the traditional ice cream mass are directed to the packing machine and packed into cups.

The ice cream packed in cups goes to the quenching chamber.

After freezing in the quenching chamber, the cups are packed in bulk packaging and stored in freezers at a temperature below −10° C. Temperatures of −10° C., −12° C. and −18° C. were tested. In all cases, the product maintained the expected sensory properties.

Comparing the obtained ice cream beads of the invention embedded in the traditional ice cream to similar ice cream beads on the market, the ice cream beads embedded in the traditional BIO ice cream mass of the invention are completely different, apart from a similar texture and a similar size of the embedded beads. Ice cream beads of the invention embedded in traditional ice cream mass with or without BIO certificate are:

1. A frozen food product in the form of shock-frozen ice cream beads, wherein the product is in the form of ice cream beads with a diameter of 1 mm to 9 mm, stabilized with a natural stabilizer, wherein a finished ice cream mass is subjected to dripping, droplets formation, and then shock freezing and is frozen in a temperature range of −140° C. to −280° C., and the obtained beaded food product is suitable for storage in cold chains with a temperature of −10° C. to −18° C., and wherein the percentage of the natural stabilizer is up to 25% of the total weight of the ice cream mixture, and wherein the natural stabilizer comprises inulin, sweeteners and egg yolk, wherein sweeteners, including sugar, are in the range of 0-9%, egg yolk is in the range of 0-2%, inulin is in the range of 4-12%, and wherein the fat content of the ice cream mass is between 0 and 16%.

2. The frozen food product of claim 1, wherein the natural stabilizer comprises sweeteners selected from sugar or sweeteners selected from xylitol, inulin, steviol glycosides, erythritol, monk fruit, and further comprises egg yolk, lecithin, carrageenan, guar gum, xanthan gum, gum arabic and/or locust bean gum, the content of sweeteners being in the range of 0 to 9%, optionally 0 to 5%.

3. The frozen food product of claim 1, wherein the natural stabilizer is introduced before dripping of the ice cream mass.

4. The frozen food product of claim 1, wherein there is no more than 250 g of natural stabilizer, including sweeteners, per kilogram of ice cream mass.

5. The frozen food product of claim 1, wherein the natural stabilizer further comprises sweeteners and/or thickeners.

6. The frozen food product of claim 1, further comprising colorants and/or flavors.

7. The frozen food product of claim 1, further comprising a fruit batch.

8. The frozen food product of claim 1, further comprising a cream selected from cow, goat, buffalo, sheep, camel and/or horse milk and/or a dairy product from cow, goat, buffalo, sheep, camel and/or horse milk, wherein the dairy product comprises lactose or not and/or vegetable drink and/or fruit juice and/or cocoa and/or coffee.

9. The frozen food product of claim 1, further comprising probiotic live bacteria cultures.

10. The frozen food product of claim 1, further comprising spirulina.

11. The frozen food product of claim 1, that is a vegan product and comprises vegetable fats, wherein the oil content of the ice cream mass is between 0 and 16%.

12. The frozen food product of claim 1, that is a product which only contains fruit juice and a natural stabilizer.

13. The frozen food product of claim 1, wherein the cryogenically frozen beads are embedded in a homogeneous ice cream mass.

14. A natural stabilizer for a frozen food product, comprising inulin, sweeteners and egg yolk, wherein the percentage of the natural stabilizer is in an amount up to 25% of the total weight of the ice cream mixture, the sweeteners, including sugar, are in the range of 0-9%, the egg yolk is in the range of 0-2%, and inulin is in the range of 4-12%.

15. The natural stabilizer of claim 14, wherein sugar or sweeteners are selected from sugar beet, sugar from sugar cane, xylitol, inulin, steviol glycosides, erythritol, monk fruit, wherein the sweeteners content is in the range of0 to 9%, optionally 0 to 5%.

16. The natural stabilizer of claim 14, further comprising carrageenan, guar gum, xanthan gum, gum arabic, locust bean gum, pectin and/or lecithin.

17. The natural stabilizer of claim 14, wherein percentage of ingredients related to the total weight of the ice cream mixture containing the natural stabilizer includes lecithin in the range of 0-2%, carrageenan content in the range of 0-0.3%, guar gum in the range of 0-0.1%, xanthan gum in the range of 0-0.1%, gum arabic in the range of 0-0.1%, locust bean gum in the range of 0-0.1%, pectin in the range of 0-0.2%, steviol glycosides in the range of 0-0.3%, erythritol in the range of 0-11%, monk fruit in the range of 0-0.4%.

18. The natural stabilizer of claim 14, wherein all ingredients are of natural origin with or without Organic certificates.

19. A method for producing a frozen food product of claim 1, comprising the following carried out sequentially:
a) adding a natural stabilizer to the ice cream base with a fat content of 0 to 16% and a temperature of +4 to +90° C.;
b) emulsifying and/or hydrating the components of the ice cream mixture at a temperature of +2 to +8° C. for at least 3 hours;
c) including or not including coloring foods and/or food colorants, fruit concentrates and/or flavors in the ice cream mass;
d) dripping of ice cream mass on a Sieve System that comprises from 1 to 6 Sieve Sets; One Sieve Set consists of the Proper sieve and 0 to 3 Auxiliary sieves, wherein the Sieve System accelerates the production of ice cream beads from 300 to 1500 kg per hour, and the Auxiliary sieves dissipate the energy of the ice cream mass;
e) formation of droplets in the process of dripping and subjecting said droplets to shock freezing in liquid gases used in cryogenics in a temperature range from −140° C. to −280° C.; thus creating ice cream beads; f) packaging of the frozen beads in airtight packages; and
g) storing in freezer with a temperature in a range of −10° C. to −18° C. and below.

20. The method for producing a frozen food product of claim 19, wherein after c) probiotic live bacterial cultures are introduced in an amount of 108 to 101° CFU/g.

21. The method for producing a frozen food product of claim 19, wherein at a stage of dripping of the ice cream mass (e), a natural stabilizer is used to stabilize the production process of ice cream beads in a bath of liquid gases used in cryogenics in a temperature range from −140° C. to −280° C. and to stabilize the product, including one or more sensory properties, and/or to stabilize the product when stored at −10° C. to −18° C.

22. The method for producing a frozen food product of claim 19, wherein (e) is additionally followed by mixing ice cream beads into a traditional ice cream mass.

23. A Sieve System for forming beads of shock frozen food products as defined in claim 1, wherein the Sieve System comprises a Sieve Set, wherein the Sieve Sets comprises a Proper sieve and from 0 to 3 Auxiliary sieves.

24. The Sieve System of claim 23, wherein the system comprises one or more Proper sieves and optionally one or more Auxiliary sieves, wherein the Proper sieves include from 1 to 6 Proper sieves, and the Auxiliary sieves include from 0 to 18 Auxiliary sieves, and wherein the diameter of the holes in the sieves is up to 3 mm and not less than 0.6 mm.

25. The Sieve System of claim 23, wherein one Sieve Set includes a Proper sieve and from 0 to 3 Auxiliary sieves, and the overall Sieve System includes from 1 to 6 Proper sieves, which accelerate production of ice cream beads from 300 to 1500 kg per hour and from 0 to 18 Auxiliary sieves dissipating energy of the ice cream mass.

26. The Sieve System of claim 25, wherein the diameter of the holes in the Proper sieves is in the range of 0.6 to 2 mm, optionally from 0.8 to 1.5 mm.

27. The Sieve System of claim 25, wherein the diameters of the holes in the Auxiliary sieves are in the range of 1.0 to 3 mm, optionally from 1.2 to 2.5 mm.

28. The Sieve System of claim 25, wherein the Proper sieves are the last and lowest sieve(s) in a system and work with laminar flow of the ice cream mixture, where surface tension forces dominate and where the velocity of the ice cream mixture tends to 0 m/s.

29. The Sieve System of claim 25, wherein Auxiliary sieves serve to dissipate energy of an ice cream mixture stream and operate at ice cream mixture flow rates greater than the Proper sieves and reach velocity of up to 20 m/s.
